(19) United States
(12) Patent Application Publication
(10) Pub. No.: US 2003/0129361 A1
(43) Pub. Date: Jul. 10, 2003

(54) Sheet formed from a flat core and from curved parts bonded thereto, and process for producing this sheet

(75) Inventors: Hans Plug, Stevensweert (NL); Glen le Clercq, Weert (NL)

Correspondence Address: Richard S. Roberts, Roberts & Mercanti, L.L.P., P.O. Box 484, Princeton, NY, 08542, US

(73) Assignee: Trespa International B.V.

(21) Appl. No.: 10/317,290

(22) Filed: Dec. 11, 2002

(30) Foreign Application Priority Data
Dec. 17, 2001 (DE) DE101 61 929.4

(51) Int. Cl. B32B 3/00

(52) U.S. Cl. 428/172

(57) ABSTRACT

A sheet which includes a hot-pressed molded thermoset resin sheet, and has a core sheet formed from a prefabricated flat sheet made from wood fibers, cellulose fibers, or wood fibers and cellulose fibers, which have been impregnated with hot-curing phenol-formaldehyde resin. The core has been hot-press-molded, using pressure, with prefabricated curved parts made from wood fibers, cellulose fibers, or wood fibers and cellulose fibers, which have been arranged on a core surface. The curved parts have uniform, nonuniform, or uniform and nonuniform distribution across the core surface. The outlines and the heights of the curved parts are identical or different in size, and the same applies to the shapes of the parts. Located on a frontal and/or reverse side of the sheet there is a decorative layer.

### BACKGROUND OF THE INVENTION

1. Field of the Invention

The invention relates to a sheet made from a flat core, and from curved parts bonded thereto, where the core has been prefabricated and the parts have been prefabricated or can be produced by press-molding loose fiber material, and, where appropriate, one or both sides of the sheet have been provided with a decorative layer, and to processes for producing this sheet.

2. Description of the Related Art

EP-A 1080879 discloses a molded thermoset resin sheet which can be hot-pressed and which, as a core, has a prefabricated flat sheet made from wood fibers and/or cellulose fibers, which have been impregnated with hot-curing phenol-formaldehyde resin. The flat sheet has thickening strips with various cross sections in opposite regions of the margin. The two surfaces of the core have been equipped with decorative layers. The thickening strips preferably have a rectangular cross section, one side of this cross section being arched or curved. This European patent application also describes a process for producing the molded thermoset resin sheet which can be hot-pressed, a feature of the process being insertion of a prefabricated sheet into an open press which comprises a mold equipped with one or more hollow regions and a smooth mold. A material identical with that from which the sheet has been manufactured is then arranged along one or more marginal regions of the sheet, and one or two decorative layers are applied to the surface(s) of the sheet combined with the material, and then the parts located between the molds are hot-pressed. The sheets thus manufactured have curved features on one side, and the reverse sides of these sheets are flat.

Sheets which have rounded edges and arched shape are produced for internal fitting-out of kitchens and bathrooms, for covering facades of buildings, and for equipping chemical and physical laboratories. These sheets often have a decorative surface, and the starting materials are supporting layers which are adhesive-bonded to one another.

For example, DE-B 2823669 discloses a process in which the sheet is heated to the extent that the supporting plies or the groups of plies which are composed of two or more supporting plies bonded to one another, these having been bonded to one another by means of a thermoplastic binder, shifted with respect to one another during forming in the heated forming region in the direction of the sheet surface, and, during or after the forming, or solely after the forming, but always at least until the binder has hardened again due to cooling. Separation of the binder joints is prevented by shape-retention units in the bending equipment.

This method constructs a synthetic resin laminated sheet which is composed of two or more supporting plies impregnated with thermoset binders and hot-pressed with one another, and which is capable of forming at a forming temperature which is higher than the hot-press-molding temperature. Between the supporting plies, or between groups of plies, each made from two or more supporting plies bonded to one another, there are layers made from a thermoplastic binder, the melting point of which is equal to or lower than the forming temperature.

EP-B-0081147 describes a decorative panel suitable for outdoor applications and composed of a compression-molded core made from fibers which have been surrounded by hot-curing phenol-formaldehyde resin, and has a decorative layer on one or both surfaces of the core. The core is composed of wood fibers and/or cellulose fibers with maximum length of 20 mm, which have been coated with a hot-curing phenol-formaldehyde resin in aqueous solution or dispersion. One embodiment of this panel is produced by hot-press-molding one or more mutually superposed, mechanically precompacted layers based on wood particles, which have been impregnated with the hot-curing phenol-formaldehyde resin, forming the core of the panel. This process cures the synthetic resin. The surfaces of the core are provided with one or two decorative layers. The wood fibers impregnated with the resin solution or resin dispersion are dried until the residual moisture is from 2 to 15% by weight, whereupon the resin cures partially. The dried fibers have random orientation and form a mat in the form of a web. This is mechanically precompacted and then one layer or two or more layers mutually superposed are heated and press-moided under conditions which cure resins. The decorative layers are applied to the precompacted mat, or to the core layer after press-molding.

These hot-pressed decorative high-pressure-laminate (HPL) sheets are what are known as compact moldings, the structure of which either is the same as that of the compact sheets of EN 438-1 or DIN 16926 or ISO 4586 or is similar to that structure. The components or layers of these compact sheets are composed of identical materials, and are obtained in high-pressure presses identical with those used for other sheets based on curable resins, and can comprise adhesive layers in particular instances, depending on the molding process. Compact moldings are self-supporting elements with stable rounding and have, as do compact sheets, decorative coloring on one or both sides, with a smooth or structured surface, and generally have coherent cut edges.

There are also known processes which cure melamine-resinified decorative paper webs and phenol-resinified core paper webs in S-shaped or L-shaped structures of defined dimension, using heat and high pressure. Another known process uses insertion of separating strips during production to restrict the thickness of the compact sheets on one side in regions where bending is to take place, the thickness here depending on the desired bending radius. Subsequent shaping is then possible in the thinner regions of the sheets, using heat in stationary bending systems. The parts retain their shape after cooling in a clamping apparatus, the mechanical strength of the regions of rounding being determined by the remaining wall thickness.

In another known process, the compact sheet is removed on one side by milling to a low wall thickness in the regions to be deformed, this thickness being dependent on the desired bending radius, and the sheet is molded in stationary bending systems, using heat. While the material is still in the clamping apparatus, the milled-out cavities are filled with liquid synthetic curing resins or are reinforced by insertion of pieces of appropriate size.

Another known process produces moldings made from compact sheets and from a compact HPL sheet subsequently adhesive-bonded thereto by milling the compact sheet, or packing it with a spacer strip prior to adhesion at the sites for subsequent molding. In another method, two compact sheets in the form of supports are combined at the intended angle, and one of the edges is milled away to give a convex rounding. A compact HPL sheet is then adhesive-bonded to this milled surface. Concave roundings can be produced by reverse-side removal of material by milling or, respectively, removal of the spacer strip.

When compact moldings are produced from single HPL plies, these single plies are laminated in thicknesses of up to 1 mm with core sheets ground on both sides to give packages comprising sheets and having the desired thickness, and the single plies are then adhesive-bonded together in clamping molds, using solvent-free, two-component adhesives, for example. The adhesive bonding of the non-absorbent single HPL plies to give coherent joints places high requirements on the two-component adhesives. The laminated packages of sheets are then bent in the desired manner in a bending apparatus.

The known processes, in which the material in the region of forming is removed by milling and the cavities in the outer layer are filled with synthetic resin casting composition in the clamping apparatus or are reinforced by inserting pieces of appropriate size are complicated, due to the large number of processing steps, such as removal of material by milling, bending, filling, or preparation of pieces of appropriate size, and downstream machining, and product quality is unsatisfactory, for example because cylindrical molds often have an irregular shape, and a multiplicity of hair cracks arise at the ends of the elements, and the material can be used only as an element with one decorative side. Although product quality is good when forming takes place in a compression mold, the female molds for compression molding are very expensive, and lack the flexibility to be useful for a variety of shapes.

The capability for forming of uncured plies from compact HPL sheets laminated to give a sheet, where the outer sides of this sheet have been equipped with melamine- or acrylic-resin outer layers, is limited by the low extensibility of the decorative outer layers.

It is an object of the invention to improve a sheet of the type described at the outset so that the sheet obtained has regular or irregular elevations or, respectively, depressions, or has corrugations on the frontal side and reverse side or on the reverse side or on the frontal side, and novel and sophisticated color/lightness effects are apparent due to the specific nature of the frontal side and reverse side.

According to the invention, this object is achieved in that the parts have regular, irregular, or regular and irregular curvature and have uniform, non-uniform, or uniform and non-uniform distribution, across a frontal and reverse side, or the frontal side or reverse side, of the sheet.

In one embodiment of the invention, the material of the sheet is high-pressure laminate or wood. The core and the parts here are composed of the same material or of different materials.

In one embodiment of the invention, the parts have been bonded to that core surface which forms the frontal side; having curved features, of the sheet, and the reverse side of the sheet has been molded flat. In another embodiment, the parts have been bonded to each of the two core surfaces, and thus form a frontal side and a reverse side of the sheet, both sides having curved features. In another embodiment, the parts have been bonded to that core surface which forms the reverse side, having curved features, of the sheet, and the frontal side of the sheet has been molded flat. The parts are composed of elevations which have bases with circular, elliptical, or parabolic cross sections, and have summits which comprise rounded tops. A sheet with frontal and reverse sides, both with curved features, or with a frontal side with curved features and a flat reverse side, or with a reverse side with curved features and a flat frontal side have a profile which is 3D (three-dimensional) and has curved features throughout. It is also possible to mold sheets in which the frontal side and reverse side are flat.

In one preferred embodiment, the sheet is a hot-pressed molded thermoset resin sheet, the core of which is a prefabricated flat sheet made from wood fibers and/or from cellulose fibers, and/or kraft paper, which have been impregnated with hot-curing phenol-formaldehyde resin, and the flat sheet has been hot-pressed, using pressure, with prefabricated curved parts made from wood fibers and/or from cellulose fibers, and/or kraft paper.

In one embodiment of the invention, the decorative layer is composed of a ply made from plastic, from paper, or from wood and to which a coating layer has been applied, and the decorative layer has a weight per unit area of from 60 to 420 g/m², in particular from 140 to 300 g/m². A coating layer is not present in every case. The decorative layer is advantageously a melamine-resin-impregnated decorative paper.

Depending on the desired thickness, the core of a molded thermoset resin sheet is composed of one or more flat, rectangular plies made from kraft paper, wood fibers, cellulose fibers, or wood fibers and cellulose fibers, which have been impregnated with hot-curing phenol-formaldehyde resin. A prefabricated sheet of this type is known from EP-B 0081147. Here, superposed, mechanically precompacted layers are press-molded with one another, using heat. The flat core thus prefabricated is also termed a prepreg. The abovementioned flat rectangular plies may also have been manufactured solely from solid wood, and the curved parts have then also been manufactured from solid wood. This core sheet made from solid wood and the curved parts made from the same material are then adhesive-bonded to one another in a press with the aid of an adhesive, using heat.

The invention also provides a process which produces molded thermoset resin sheets and which uses very few steps in the process, and comprises arranging one or two decorative layers in molds of an open press, one or both molds of which have hollow regions, inserting a prefabricated flat core made from kraft paper, wood fibers, cellulose fibers, and/or solid wood, or from a mixture of wood fibers and cellulose fibers into the open press, charging the hollow regions with prefabricated parts made from kraft paper, wood fibers, cellulose fibers, and/or solid wood, or from loose resin-impregnated wood fibers, cellulose fibers, and/or shredded kraft paper, or a mixture of wood fibers and cellulose fibers, and hot-pressing all of the materials located between the molds. One embodiment of the process comprises arranging one or two decorative layers in molds of an open press, both molds of which have hollow regions, inserting a prefabricated flat core made from kraft paper, wood fibers, and/or cellulose fibers, or solid wood into the open press, charging the hollow regions with prefabricated parts made from kraft paper, wood fibers, cellulose fibers, and/or solid wood, or a mixture of wood fibers and cellulose fibers, or charging with loose resin-impregnated wood fibers, cellulose fibers, and/or shredded kraft paper, or with resin-impregnated wood fibers and resin-impregnated cellulose fibers mixed with one another, and hot-pressing all of the materials located between the molds. A preferred method press-molds the materials in the press using a temperature of from 130 to 180° C. and a pressure of from 60 to 110 bar.

The invention achieves the advantages of constructing, in a very simple manner, variably, and with curved features, the frontal side and reverse side of a sheet with curved elevations which have identical or different shapes, the result being that even if the coloration is monochromatic the sides or surfaces of the sheets are given a sophisticated visual color effect with variations due to color/lightness effects.

### SUMMARY OF THE INVENTION

The invention provides a sheet comprising a flat core and curved parts bonded thereto, wherein the core has been prefabricated and the parts can be prefabricated or produced by press-sheeting loose fiber material, and wherein one or both sides of the sheet have been equipped with a decorative layer, wherein the parts have regular, irregular, or both regular and irregular curvature, and have uniform, nonuniform, or both uniform and nonuniform distribution over a frontal and/or reverse side of the sheet.

The invention also provides a sheet comprising a prefabricated core, and prefabricated parts bonded to the core, and further comprising a decorative layer on one or both sides of the sheet, wherein the sheet has depressions which have regular, irregular, or both regular and irregular curvature.

The invention further provides a process for producing a sheet, which comprises inserting a prefabricated flat core made from kraft paper, wood fibers, cellulose fibers, and/or solid wood, or from a mixture of wood fibers and cellulose fibers, into an open press having two molds which have hollow regions, charging the hollow regions with prefabricated parts made from kraft paper, wood fibers, cellulose fibers, and/or solid wood, or from loose resin-impregnated wood fibers, cellulose fibers, and/or shredded kraft paper, or from a mixture of resin-impregnated wood fibers and resin-impregnated cellulose fibers, closing the press, and hot-pressing all of the prefabricated parts located in the press or of the loose resin-impregnated fibers with the core, opening the press, arranging one or two decorative layers on one or both sides of the core and on the parts bonded thereto, and then closing the press and hot-pressing the decorative layer or layers with the core and with the parts bonded thereto, to thereby form a 3D sheet with curved features on both sides.

### BRIEF DESCRIPTION OF THE DRAWINGS

FIG. 1 is a diagrammatic plan view of a prefabricated core sheet and of parts bonded to the core within a sheet of the invention.

FIG. 2 is a diagrammatic sectional view of an open press with one flat mold and one mold designed with hollow regions, with decorative layers, inserted core, and prefabricated curved parts, which form elevations of the sheet after press-molding.

FIG. 3 is a sectional view of a finished sheet whose frontal side and reverse side have a decorative layer.

FIG. 4 is a diagrammatic sectional view of an open press, similar to the press of FIG. 2, with two molds, each of which has been equipped with hollow regions.

FIG. 5 is a diagram of hollow regions charged with wood fibers and/or with cellulose fibers, in a mold.

FIG. 6 is a perspective view of an inventive embodiment of a sheet with elevations on the frontal side and with a flat reverse side.

FIG. 7 is a plan view of a facade covering composed of sheets of the invention, the frontal side of the covering having corrugations or curved features due to elevations.

FIG. 8 is a diagrammatic sectional view of an open press with two molds equipped with elevations, with decorative layers and inserted core with depressions.

FIG. 9 is a diagrammatic sectional view of an open press, similar to the press of FIG. 8, with one flat mold and with one mold equipped with elevations, with decorative layers and flat parts, and also with a core with depressions on one side.

FIG. 10 is a perspective view of another embodiment of a sheet of the invention with depressions on the frontal side and with a flat reverse side.

### DETAILED DESCRIPTION OF THE PREFERRED EMBODIMENT

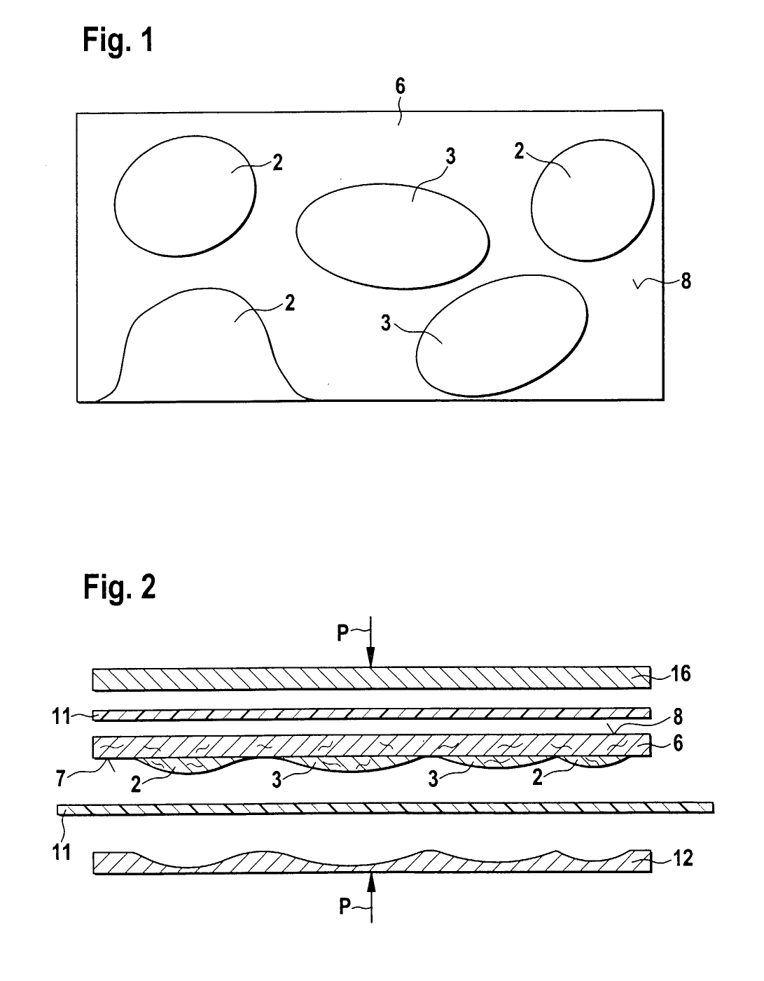

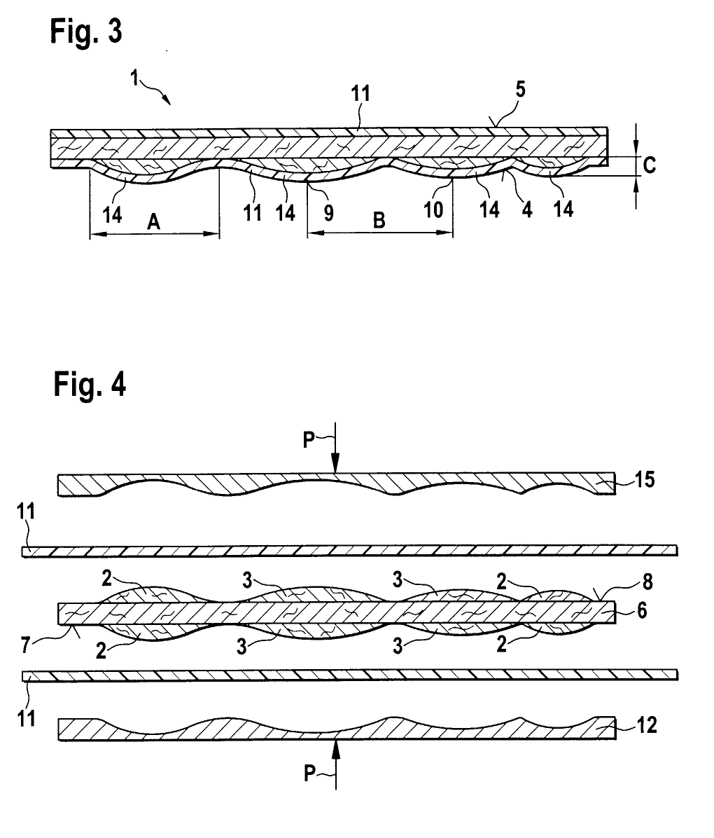

FIG. 1 shows a diagrammatic plan view of a core sheet 6 with parts 2 and 3, for example bonded to that core surface 8 which forms a frontal side 4 of a finished sheet 1, as shown in the sectional view of FIG. 3.

The material used for the parts 2 and 3 may comprise the same material as that of the core sheet 6, but it is possible to use different materials for the parts 2, 3 and the core 6. In preferred embodiments of the invention, the core 6 and the parts 2 and 3 may comprise wood fibers, cellulose fibers, or a mixture of wood fibers and cellulose fibers, impregnated with a resin, or may comprise solid wood, where one or more layers made from kraft paper provide, or may provide, a protective covering on one or both sides for the parts 2, 3 and the core 6. In a preferred embodiment, the core 6 is flat, and the parts 2, 3 are curved.

FIGS. 1 to 10 and the associated description are based on the preferred embodiments of the invention. Preferably, the sheets comprise a high-pressure laminate or wood.

The core 6 shown in FIG. 1, for example, may be prefabricated from support plies, and comprise wood fiber particles and/or cellulose fiber particles, and be formed by a process such as that described in EP-B-0081147, omitting decorative layers. There are also plies provided made from kraft paper, on one or both sides of the core. The manner in which this takes place is that one or more superposed, mechanically compacted layers based on wood fiber particles and/or on cellulose fiber particles, which have been impregnated with a hot-curing phenol-formaldehyde resin are press-molded together with kraft paper plies, using heat, whereupon the synthetic resin is cured. To this end, wood fibers and/or cellulose fibers with a maximum length of about 20 mm are coated or impregnated with more than about 15% by weight, and up to about 90% by weight, of the hot-curing phenol-formaldehyde resin, based on the fiber weight, in aqueous solution or dispersion. The fibers are dried until residual moisture ranges from about 2% to about 15% by weight, whereupon the resin cures partially and the dried fibers in random orientation are molded to give a mat in the form of a web. The mat is mechanically precompacted and then, in one or more superposed layers, heated and press-molded under conditions which cure resins. By this stage, the mats generally have the desired sheet format, but if this is not the case, the sheets are manufactured with the required dimensions from the mats. As mentioned above, the material of parts 2 and 3 preferably comprise substantially the same material as that of the prefabricated core sheet 6, but parts 2 and 3 may also be manufactured from different materials.

FIG. 2 shows a diagrammatic view of an open press which comprises two molds, 12 and 16. The mold 12 takes the form of a female mold in which, as required, comprise a plurality of hollow regions, the distribution of which across the surface of the mold 12 may be uniform, non-uniform, or both uniform and non-uniform. The outlines of the hollow regions may be circular, elliptical, or parabolic, and the dimensions of these outlines generally differ for each of these outlines of the same type, but may also be substantially the same. The depth of the hollow regions generally differ. The other mold 16 preferably comprises a flat, i.e. smooth press platen, which has no hollow regions or elevations. The location of the prefabricated core 6 is between the open molds 12, 16, and that of the parts 2 and 3 is in the mold 12. The molds 12 and 16 are advanced toward one another in the direction of the arrows P, P, and the prefabricated core 6 and the parts 2 and 3 are then press-molded with one another, using heat and appropriately high pressure. The parts 2 and 3 have been prefabricated from a material which preferably comprises kraft paper, wood fibers, and/or cellulose fibers, or from a mixture of wood fibers and cellulose fibers, or from solid wood. The press is then opened, and two decorative layers 11, 11 are placed on the surfaces of the core 6 and on the parts 2, 3 bonded thereto. The press is then closed and further hot-pressing takes place. The lower decorative layer 11 here is preferably longer and wider than the upper decorative layer in FIG. 2, since, as compared with the upper decorative layer 11, it has to cover a larger surface. The larger surface results from the parts 2 and 3 applied to one surface 7 of the core 6. The outlines of the parts 2 and 3 are substantially similar to those of the hollow regions of the mold 12. The dimensions of the outlines of the hollow regions and of the parts 2, 3 preferably differ from one another only by the thickness of the decorative layer 11. It is advantageous for both of the molds 12 and 16 to be heatable electrically in a manner not shown for hot-pressing. The temperature during hot-pressing preferably ranges from about 130° C. to about 180° C., and the pressure applied preferably ranges from about 60 to about 110 bar in all of the production processes of the invention.

FIG. 3 shows a cross section of a finished molded thermoset resin sheet 1, which includes elevations 14 corresponding to the parts 2 and 3 and their arrangement on the prefabricated core 6. The sides of the molded thermoset resin sheet 1 have been provided with decorative layers 11, 11. Of course, it is also possible for there to be only one decorative layer applied if this is desired, i.e. during the pressing procedure it is possible for only the lower, or only the upper, decorative layer 11 to be arranged between the molds 12 and 16 as in FIG. 2. The reverse side 5 of the sheet 1 is preferably flat, whereas the frontal side 4 has the elevations 14, the summits of the elevations being the rounded tops 9 and 10. The size A of the cross section of the elevations 14 preferably ranges from about 100 mm to about 500 mm, and the distance B between the rounded tops 9 and 10 of adjacent elevations 14 preferably ranges from about 100 mm to about 800 mm. The elevations have different dimensions in their cross sections, but they also have substantially the same dimensions if the shape is similar. The height difference between two rounded tops 9 and 10 preferably ranges from about 2 mm to about 10 mm.

The core sheet 6 shown in FIG. 2 preferably has a thickness ranging from about 8 mm to about 20 mm, in particular from about 8 mm to about 12 mm. The maximum length of a sheet 1 is preferably up to about 4400 mm, and its maximum width is preferably up to about 2400 mm, but preferred sheet dimensions preferably range from about 600 mm×about 600 mm to about 3000 mm×about 1800 mm.

The sheet 1 shown in FIG. 3 is obtained by hot-pressing the core 6 with the parts 2 and 3, and subsequently applying the decorative layers 11, 11 as in FIG. 2. As can be seen from FIG. 2, the parts 2 and 3 have been bonded to that core surface 7 which forms the frontal side 4, having curved features, of the sheet 1, whereas the reverse side 5 of the sheet 1 has been molded flat.

FIG. 4 shows a diagram of a view of an open press which is similar to the press in FIG. 2 except that the smooth upper mold 16 of FIG. 2 has been replaced by a mold 15 with hollow regions. The two molds 12 and 15 are female molds in each of which there may, if required, comprise a plurality of hollow regions, which may comprise uniform, non-uniform, or both uniform and non-uniform distribution across the surface, and which may comprise regular, irregular, or regular and irregular shape. Two decorative layers 11, 11 have been arranged between the open molds 12, 15, and the location of the prefabricated core 6 is between the decorative layers. Parts 2 and 3 have been arranged in the hollow regions of the molds 12, 15. The molds 12 and 15 are advanced toward one another in the direction of the arrows P, P, and the decorative layers 11, 11 and the prefabricated core sheet 6 are press-molded with the parts 2 and 3, using heat. The two decorative layers 11, 11 are longer and wider than the core 6, since they also have to cover the curved parts 2 and 3. This type of pressing process manufactures a three-dimensional (3D) sheet which has curved features on both sides and has a frontal side with curved features and also a reverse side with curved features. Of course, it is also possible for the parts 2 and 3 to have been bonded only to that surface 8 of the core 6 which forms the reverse side 5, with curved features, of a sheet 1, whereas the frontal side 4 of the sheet 1 has been molded flat.

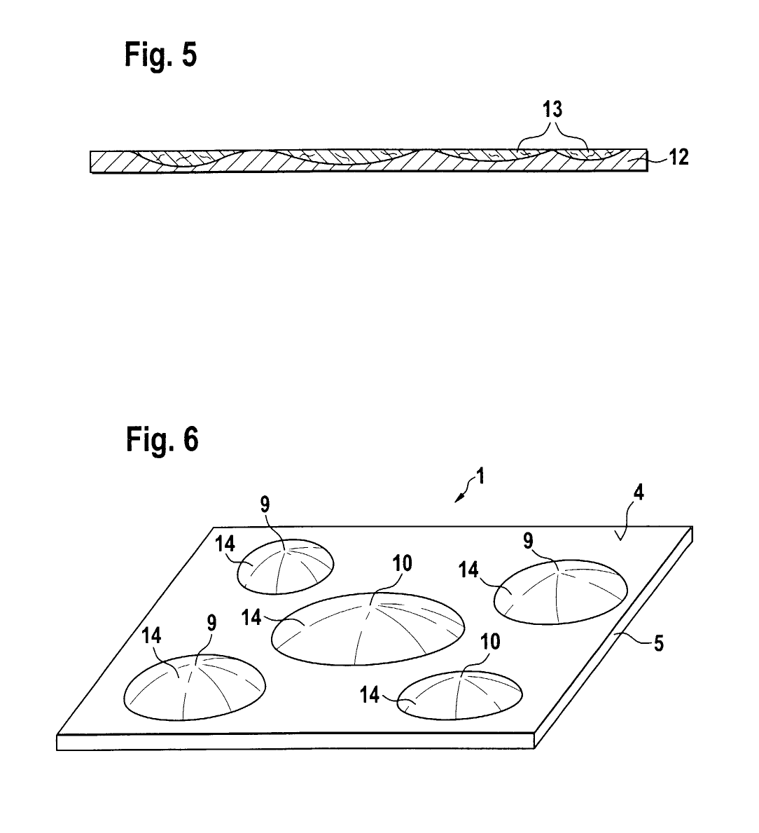

Instead of prefabricated parts 2 and 3, the material 13 used for forming the elevations 14 of the sheet 1 may comprise loose wood fibers, cellulose fibers, shredded kraft paper, or wood fibers and cellulose fibers mixed with one another, as shown in FIG. 5, these being mechanically compacted before charging to the hollow regions of the mold 12. These wood fibers, cellulose fibers, or shredded kraft paper, or mixture of wood fibers and cellulose fibers have preferably been impregnated with phenol-formaldehyde resin and preferably comprise substantially the same composition as the materials used for producing the prefabricated core 6. The method of production of the sheet 1 here is that, once the material has been charged to the hollow regions, the prefabricated core sheet 6 is inserted into the open press, and the press is briefly closed and subjected to heat and pressure until the loose fibers in the hollow regions of the mold 12 have become securely bonded to the core. The press is then opened and, depending on requirements, one or two decorative layers are applied to the surface(s) of the core 6, with the parts 2 and 3 bonded thereto. The press is then closed again and hot-pressing is continued until an appropriate sheet 1, for example as shown in FIG. 3, has been produced.

It is also possible for prefabricated parts made from solid wood to be inserted into the hollow regions of the mold 12 as in FIG. 5, these then being heat-bonded under pressure or hot-molded to an appropriate core sheet made from solid wood in the press.

In the processes described it is also possible to use a press with two flat molds in order to bond a core securely to flat parts, using heat and pressure.

If the sheet 1 comprises a hot-pressed molded thermoset resin sheet, it preferably has a uniform density ranging from about 1.1 g/cm³ to about 1.8 g/cm³, in particular from about 1.3 g/cm³ to about 1.5 g/cm³, across its entire cross section, i.e. including the elevations 14. The density, and also the physical and technical properties, of the molded thermoset resin sheet 1 are preferably substantially uniform across the regions provided with, and not provided with, curved features on the sheet.

The decorative layers 11, 11 are composed of a ply made from plastic, from paper, or from wood and to which a coating layer has been applied, and the decorative layer preferably has a weight per unit area ranging from about 60 g/m² to about 420 g/m², in particular from about 140 g/m² to about 300 g/m². It is also possible for the decorative layers 11, 11 to comprise a crosslinked acrylic, urethane, epoxy, or melamine resin, and the acrylic resin may have been pigmented. It is also possible for fillers or dyes, alone or in combination, to be added to the resin as additives. In another embodiment, the decorative layers 11, 11 comprise decorative papers which have been resinified with melamine. In particular in the case of panels, but also in the case of sheets for interior construction work or for use in laboratories, the phenol-formaldehyde resin used to impregnate the wood fibers and/or cellulose fibers comprises a flame-retardant additive.

FIG. 6 shows a perspective view of a sheet 1 with frontal side 4 which has curved features. It has elevations 14 with rounded tops 9 and 10. The reverse side 5 of the sheet 1 is flat. When light is incident on a sheet 1 of the invention, the various elevations 14 result in variations in illumination and reflection, producing color/shadow effects which give rise to a specific appearance which provides variation in the monochromatic color of the decorative layers 11 and gives additional distinctiveness to the surface corrugations or curved features on the sheet 1.

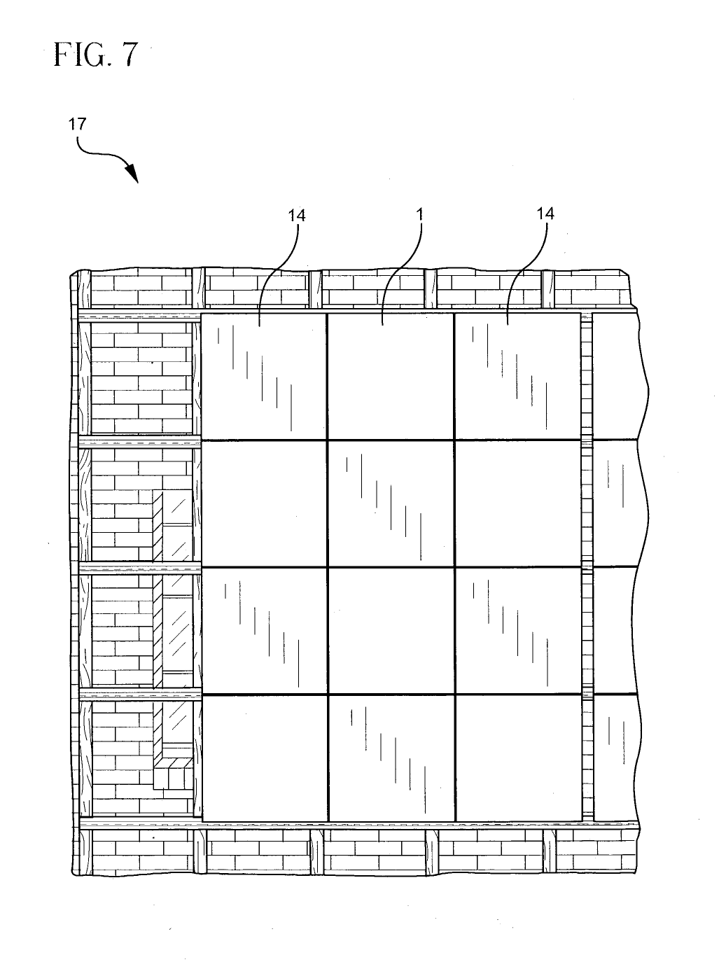

FIG. 7 shows a plan view of a facade covering 17, composed of a plurality of sheets of the invention. The single sheets have, for example, a frontal side which has corrugation or curved features by virtue of elevations 14. The sheets used for these facade coverings generally have dimensions of about 4400 mm×about 2400 mm, but preference is given to dimensions ranging from about 600 mm×about 600 mm to about 3000 mm×about 1800 mm.

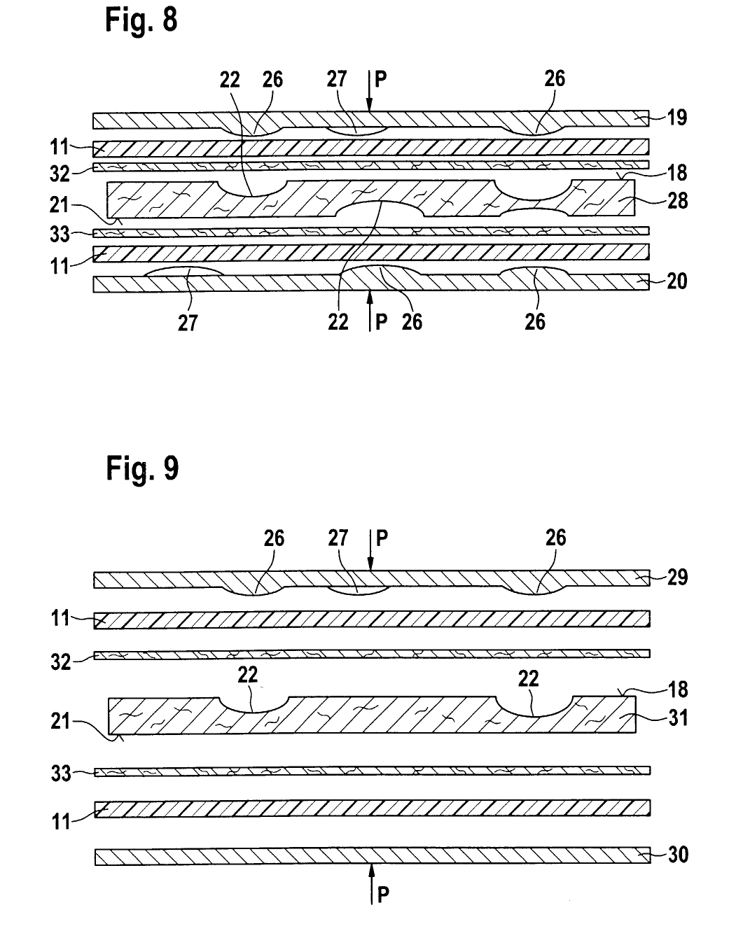

FIG. 8 shows a diagram of a view of an open press which has two molds 19 and 20. The mold 19 is a female moldin which, depending on requirements, there is a plurality of elevations 26, 27, with uniform, nonuniform, or both uniform and nonuniform distribution across the surface of the mold 19. The outlines of the elevations 26, 27 are circular, elliptical, or parabolic, and the dimensions of these outlines generally differ for each of the outlines of the same type, but may also be substantially the same. Heights of the elevations 26, 27 generally differ. The sections through the elevations 26 are in the plane of the drawing, whereas the position of the elevations 27 exists behind the plane of the drawing, for example.

The other mold 20 has also been equipped with elevations 26, 27. Located between a prefabricated flat part 32 above the upper core surface 18 and the mold 19 there is a decorative layer 11, and the same applies between a prefabricated flat part 33 below the lower core surface 21 and the mold 20. The two decorative layers 11, 11 are preferably longer and wider than the core 28, since they also have to fill in and cover the depressions 22 of the core 28 during the pressing procedure together with the parts 32, 33. The elevations 26, 27 of the two molds 19 and 20 have substantially the same outlines as the depressions 22 of the core 28, and the depressions 22 and elevations 26, 27 are opposite and congruent.

The core 28, the parts 32, 33, and the decorative layers 11, 11 preferably comprise the same materials as those described above in the context of FIGS. 1 to 7. It is advantageous for both molds 19, 20 to be heatable electrically in a manner not shown for hot-pressing. The temperature during hot-pressing ranges from about 130° C. to about 180° C., and the pressure exerted ranges from about 60 to about 110 bar.

An example of a design of the core 28 in FIG. 8 is such that it comprises depressions 22 only in the upper core surface 18, whereas the lower core surface 21 is flat. The lower mold 20 is then also flat. The decorative layers 11, 11 may also be laminated directly onto the core 28, omitting the parts 32, 33.

FIG. 9 shows a diagram of an open press which comprises two molds 29, 30, the upper mold 29 of which has been designed as a female mold which has a plurality of elevations 26, 27. The elevations may have uniform, nonuniform, or both uniform and nonuniform distribution across the surface of the mold 29. The shape or the outlines of the elevations 26, 27, and also the dimensions of the elevations, are the same as those described in the context of FIG. 8. The lower mold 30 is preferably flat. Located between the open molds 29 and 30 there are decorative layers 11, 11, and also flat parts 32 and 33. The material of which these parts 32, 33 preferably comprise the same material as that of a core 31, which comprises depressions 22 in the upper core surface 18, whereas the lower core surface 21 is flat. The outlines of the elevations 26, 27 of the mold 29 are similar to those of the depressions 22 of the core 31. The dimensions of the outlines of the elevations 26, 27 and of the depressions 22 differ from one another only by the thickness of the decorative layer 11 and of the prefabricated part 32. In other words, the outlines take into account the fact that the respective thicknesses of the prefabricated part 32 and of the decorative layer 11 mean that during press-molding they fill in the depressions 22. If the sheet is intended to have low thickness, the prefabricated parts can be omitted during the compression-molding procedure, so that the decorative layers 11, 11 are laminated directly onto the core 28 and, respectively, 31. The materials of the parts 32, 33 and of the core layer 28 and, respectively, 31 preferably comprise the same materials as described under FIGS. 1 to 7.

The compression-molding procedure is that the molds 29, 30 are advanced toward one another in the direction of the arrows P, P, and the core 31 is hot-pressed with the parts 32, 33 and with the decorative layers 11, 11 under pressure, using heat and appropriately high pressure. The upper decorative layer 11 and the upper part 32 are longer and wider than the core 31, since they also have to cover the depressions 22 of the core 31. The lower part 33 and the lower decorative layer 11 have substantially the same dimensions as the lower core surface 21 of the core 31. The press-molding takes place in one stage, and the intention is not that the core 31 and the parts 32 and 33 be first press-molded with one another, nor that on completion of that process a second compression-molding procedure, using pressure, be then used to hot-press the decorative layers 11, 11 with the parts 32, 33 joined to the core 31 in the first compression-molding step. A compression-molding procedure of this type is intended for instances in which the thickness of the prefabricated core 31 is too low, and a sheet of the required thickness can be manufactured only by press-molding with the parts 32, 33.

The compression-molding procedure of FIG. 9 may, of course, also use a core 31 which includes depressions 22 on both the frontal side and the reverse side. It is then merely necessary for the lower mold 30 to be similar to the upper mold 29 in being equipped with elevations 26, 27 whose outlines are similar to the outlines of the depressions 22 and which, as described above, have to be brought into congruent alignment with these during the compression-molding procedure.

The compression-molding procedures described on the basis of FIGS. 8 and 9 produce sheets which have depressions on their frontal sides and have a flat reverse side, or have depressions on both the frontal and the reverse side. The press-molding of the cores described with two flat parts produces 3D sheets which have depressions at the locations of the depressions in the core. This therefore gives sheets with curved features on one or both sides, with concave cross sections of the curved features or depressions, with respect to the other flat parts of the surfaces of the sheets.

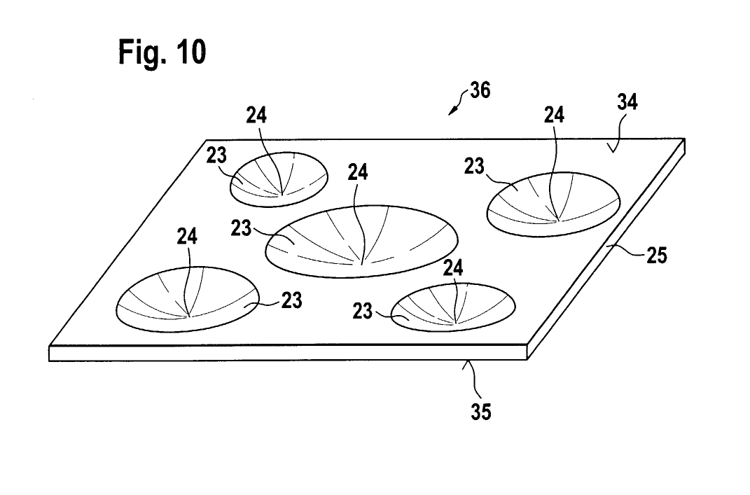

FIG. 10 shows a perspective diagram of a sheet 36 of this type, with depressions 23. The location of these depressions 23 exists on a frontal side 34 of this sheet 36. The reverse side 35 of the sheet 36 may either be flat or also have depressions 23 of this type. The bases of the depressions 23 have circular, elliptical, or parabolic cross sections, and have points of depression 24.

The sheets of the invention may be used for covering walls in the interiors of buildings, or as partition walls.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A sheet comprising a flat core and curved parts bonded thereto, wherein the core has been prefabricated and the parts can be prefabricated or produced by press-sheeting loose fiber material, and wherein one or both sides of the sheet have been equipped with a decorative layer, wherein the parts have regular, irregular, or both regular and irregular curvature, and have uniform, nonuniform, or both uniform and nonuniform distribution over a frontal and/or reverse side of the sheet.

2. The sheet as claimed in claim 1, wherein the material of the sheet comprises a high-pressure laminate or wood.

3. The sheet as claimed in claim 2, wherein the core and the parts comprise substantially the same material or different materials.

4. The sheet as claimed in claim 1, wherein the parts have been bonded to a surface of the core which forms the frontal side of the sheet, having curved features, and wherein the reverse side of the sheet has been molded flat.

5. The sheet as claimed in claim 1, wherein the parts have been bonded to each of the two core surfaces, thus forming a frontal and a reverse side of the sheet, both having curved features.

6. The sheet as claimed in claim 1, wherein the parts have been bonded to a surface of the core which forms the reverse side of the sheet, having curved features, and wherein the frontal side of the sheet has been molded flat.

7. The sheet as claimed in claim 1, wherein the parts comprise elevations which have bases with circular, elliptical, or parabolic cross sections, and have summits which comprise rounded tops.

8. The sheet as claimed in claim 7, wherein a width dimension “A” of cross sections of the elevations ranges from about 100 mm to about 500 mm.

9. The sheet as claimed in claim 7, wherein the dimensions of the elevations are substantially the same, or different.

10. The sheet as claimed in claim 7, wherein a distance “B” between rounded tops of adjacent elevations ranges from about 100 mm to about 800 mm.

11. The sheet as claimed in claim 1, wherein the height difference between two rounded tops ranges from about 2 mm to about 10 mm.

12. The sheet as claimed in claim 1, wherein the core has a thickness of from about 8 mm to about 20 mm, a maximum length of up to about 4400 mm, and a maximum width of up to about 2400 mm.

13. The sheet as claimed in claim 1, wherein the sheet comprises a hot-pressed molded thermoset resin sheet, the core of which comprises a prefabricated flat sheet comprising wood fibers or from cellulose fibers, and/or kraft paper, or from a mixture of wood fibers and cellulose fibers, and/or shredded kraft paper, where the respective fibers have been impregnated with hot-curing phenol-formaldehyde resin, and wherein the flat sheet has been hot-pressed, using pressure, with prefabricated curved parts comprising wood fibers and/or from cellulose fibers, and/or kraft paper.

14. The sheet as claimed in claim 13, which has, across its entire cross section, a density ranging from about 1.1 g/cm³ to about 1.8 g/cm³.

15. The sheet as claimed in claim 12, further comprising a phenol-formaldehyde resin which contains a flame-retardant additive.

16. The sheet as claimed in claim 13, further comprising a phenol-formaldehyde resin which contains a flame-retardant additive.

17. The sheet as claimed in claim 1, wherein the decorative layer comprises a ply which comprises plastic, paper, or wood, and to which ply a coating layer has been applied, and wherein the decorative layer has a weight per unit area ranging from about 60 g/cm² to about 420 g/m².

18. The sheet as claimed in claim 1, wherein the decorative layer comprises a crosslinked acrylic, urethane, epoxy, or melamine resin, wherein the resin has been pigmented, and wherein fillers or dyes, or both fillers and dyes, have been added to the resin.

19. The sheet as claimed in claim 1, wherein the decorative layer comprises a melamine-resin-impregnated decorative paper.

20. The sheet as claimed in claim 1, wherein the material for the curved parts comprise loose resin-impregnated wood fibers and/or loose resin-impregnated cellulose fibers, and/or shredded kraft paper, or of a mixture of wood fibers, cellulose fibers, and/or shredded kraft paper, this material having been formed by being charged to hollow regions of a mold, wherebetween this mold and another mold, the prefabricated flat core sheet and the loose material in the hollow regions have been hot-press-molded to one another, and wherein one or two decorative layers have been laminated onto the core and onto the parts bonded thereto.

21. A sheet comprising a prefabricated core, and prefabricated parts bonded to the core, and further comprising a decorative layer on one or both sides of the sheet, wherein the sheet has depressions which have regular, irregular, or both regular and irregular curvature.

22. The sheet as claimed in claim 21, wherein the depressions have uniform, nonuniform, or both uniform and nonuniform distribution over a frontal side of the sheet.

23. The sheet as claimed in claim 21, wherein the depressions have been distributed over the reverse side of the sheet.

24. The sheet as claimed in claim 21, wherein the depressions have been distributed over the frontal side and the reverse side of the sheet.

25. The sheet as claimed in claim 21, wherein an upper surface of the core comprises depressions.

26. The sheet as claimed in claim 25, wherein a lower surface of the core comprises depressions.

27. The sheet as claimed in claim 25, wherein a lower surface of the core is flat.

28. A covering for facades or for walls, comprising a plurality of sheets as claimed in claim 1.

29. A covering for the interior of a building, comprising a plurality of sheets as claimed in claim 1.

30. A process for producing a sheet as claimed in claim 1, which comprises inserting a prefabricated flat core made from kraft paper, wood fibers, cellulose fibers, and/or solid wood, or from a mixture of wood fibers and cellulose fibers, into an open press having two molds which have hollow regions, charging the hollow regions with prefabricated parts made from kraft paper, wood fibers, cellulose fibers, and/or solid wood, or from loose resin-impregnated wood fibers, cellulose fibers, and/or shredded kraft paper, or from a mixture of resin-impregnated wood fibers and resin-impregnated cellulose fibers, closing the press, and hot-pressing all of the prefabricated parts located in the press or of the loose resin-impregnated fibers with the core, opening the press, arranging one or two decorative layers on one or both sides of the core and on the parts bonded thereto, and then closing the press and hot-pressing the decorative layer or layers with the core and with the parts bonded thereto, to thereby form a 3D sheet with curved features on both sides.

31. A process for producing a sheet as claimed in claim 1, which comprises inserting a prefabricated flat core made from kraft paper, wood fibers, cellulose fibers, and/or solid wood, or from a mixture of wood fibers and cellulose fibers, into an open press having two molds, one mold of which has hollow regions and the other mold of which is flat, introducing prefabricated parts made from kraft paper, wood fibers, cellulose fibers, and/or solid wood, or from a mixture of wood fibers and cellulose fibers into the hollow regions, or charging the hollow regions with loose resin-impregnated wood fibers, cellulose fibers, and/or shredded kraft paper, closing the press, and hot-pressing all of the parts located in the press with the core, opening the press, arranging one or two decorative layers on one or both sides of the core and on the parts bonded thereto, and then closing the press and hot-pressing the decorative layer or layers with the core and with the parts bonded thereto, to thereby form a 3D sheet with curved features on one side.

32. A process for producing a sheet as claimed in claim 1, which comprises inserting a decorative layer into one or each of two molds of an open press, each mold equipped with hollow regions, charging the hollow regions of each of the two molds with prefabricated parts made from kraft paper, wood fibers, cellulose fibers, and/or solid wood, or a mixture of wood fibers and cellulose fibers, or charging with loose resin-impregnated wood fibers, loose resin-impregnated cellulose fibers, and/or shredded kraft paper, or resin-impregnated wood fibers and resin-impregnated cellulose fibers mixed with one another, inserting a prefabricated flat core made from material which is the same as or different from that which has been charged to the hollow regions, closing the molds, and hot-pressing outer layer or layers, core, and prefabricated parts or loose resin-impregnated fibers, to thereby form a 3D sheet with curved features on both sides.

33. A process for producing a sheet as claimed in claim 1, which comprises inserting a decorative layer into one or each of the two molds of an open press, each mold equipped with hollow regions, one mold of which is flat and the other mold of which has hollow regions, charging the hollow regions of one mold with prefabricated parts made from kraft paper, wood fibers, cellulose fibers, and/or solid wood, or a mixture of wood fibers and cellulose fibers, or charging with loose resin-impregnated wood fibers, resin-impregnated cellulose fibers, and/or shredded kraft paper, or with resin-impregnated wood fibers and resin-impregnated cellulose fibers mixed with one another, inserting a prefabricated flat core made from material which is the same as or different from that which has been charged to the hollow regions of one of the molds, closing the molds, and hot-pressing the layer or layers, core, and prefabricated parts or loose resin-impregnated fibers, to thereby form a 3D sheet with curved features on one side.

34. A process for producing a sheet as claimed in claim 21, which comprises inserting a decorative layer into one or each of two molds of an open press, inserting flat prefabricated resin-impregnated parts, and inserting, located between these, a resin-impregnated core, equipped with depressions, and comprising a material substantially the same as or different from that of the prefabricated parts, closing the molds, and hot-pressing the layer or layers, prefabricated parts, and core, to thereby form a sheet with curved features on one or both sides.

35. The process as claimed in claim 30, wherein the materials are press-molded in the press using a temperature ranging from about 130° C. to about 180° C. and a pressure of from about 60 bar to about 110 bar.
